(19) United States
(12) Patent Application Publication
(10) Pub. No.: US 2025/0292916 A1
(43) Pub. Date: Sep. 18, 2025

(54) Apparatus and Methods for Harvesting Energy from an Axially Expanding Plasma Contained by a Magnetic Field

(71) Applicant: Helion Energy, Inc., Everett, WA (US)

(72) Inventors: David Kirtley, Seattle, WA (US); Christopher James Pihl, Woodinville, WA (US); James Melvin Pihl, Port Ludlow, WA (US)

(73) Assignee: Helion Energy, Inc., Everett, WA (US)

(21) Appl. No.: 19/222,236

(22) Filed: May 29, 2025

Related U.S. Application Data
(63) Continuation of application No. PCT/US2023/082815, filed on Dec. 7, 2023.
(60) Provisional application No. 63/386,364, filed on Dec. 7, 2022.

(51) Int. Cl. G21B 1/05; G21B 1/21

(52) U.S. Cl. CPC G21B 1/052; G21B 1/21

(57) ABSTRACT

A magnetic field system can generate intense, dynamically varying magnetic fields to confine and control particles, objects, or plasmas. Coils in the magnetic field system, used to control a plasma, can be used to harvest energy from an expanding plasma.

### CROSS-REFERENCE TO RELATED APPLICATION(S)

This application is a bypass continuation of International Application No. PCT/US2023/082815, filed Dec. 7, 2023, which claims the priority benefit, under 35 U.S.C. 119 (e), of U.S. Application 63/386,364, filed Dec. 7, 2022. Each of these applications is incorporated herein by reference in its entirety for all purposes.

### BACKGROUND

Intense magnetic fields may be generated with a plurality of current-carrying coils that are driven with large electrical currents and high voltages. Such magnetic fields may be used to confine high-energy particles and/or to accelerate particles or objects to high velocities. In some cases, intense magnetic fields may be used to confine a plasma.

### SUMMARY

The described implementations relate to methods and apparatus for dynamically controlling plasmas contained within intense magnetic fields. The relevant plasmas include (i) coherent structures of plasmas and magnetic fields (plasmoids), and/or (ii) mirror-confined plasmas. The magnetic fields may be produced with an assembly of electromagnetic coils (referred to more succinctly as “magnetic coils” or “coils”) that are controlled to confine and/or impart energy to the contained plasmas. In some cases, the magnetic coils may be used to harvest energy directly and repeatedly from the expanding plasmas. For repeated energy exchange with a plasma (e.g., delivery of energy to and harvesting of energy from the plasma), at least a portion of the magnetic field produced by the magnetic coils may be controlled spatially and temporally to pulsate the plasma.

More specifically, current running through the magnetic coils generates a magnetic field that drives the adiabatic compression of a plasma, performing work on the plasma by compressing it in radius and length, and increasing plasma temperature. As the temperature of the plasma increases, fusion of the constituent ions in the plasma occurs, producing highly energetic charged particles which can remain confined in the plasma and increase the energy of the plasma. This causes the plasma's temperature to rise and causes the plasma to expand axially against the magnetic field applied by the magnetic coils. This plasma expansion cycle results in increasing the magnetic field around the magnetic coils, which in turn produces an electromotive force via Lenz's law that drives a current into an energy storage element coupled to the magnetic coils. In some implementations, this harvested energy can be diverted to a load, including an energy storage system.

In some aspects, the techniques described herein relate to harvesting energy from a plasma (e.g., a field-reversed configuration (FRC) plasma). Magnetic coils apply a magnetic field to the plasma. This magnetic field adiabatically compresses the plasma, causing the plasma to undergo compression, heating, and fusion. The compression, heating, and fusion cause the plasma to undergo axial expansion, which transfers energy to the magnetic coils. This energy is directed from the magnetic coils to an energy-storage component, such as a capacitor.

Adiabatically compressing the plasma may include increasing current running through the magnetic coils so as to increase an amplitude of the magnetic field.

Directing the energy from the magnetic coils to the energy-storage component can include resonantly transferring the energy from the magnetic coils to the energy-storage component.

In some cases, the current in at least one of the magnetic coils is crowbarred while the plasma undergoes the compression, heating, and fusion to further resist radial expansion of the plasma and promote the axial expansion of the plasma. Alternatively, the magnetic field can be adjusted to radially over-compress (the center of) the plasma while the plasma undergoes the compression, heating, and fusion in order to promote the axial expansion of the plasma.

The compression, heating, and fusion can cause radial expansion of the plasma that generates additional current in the magnetic coils, in which case this additional current can be stored as additional energy in the energy-storage component.

The energy from the energy-storage component can be converted into an electrical current, e.g., direct current or alternating current.

Some implementations relate to a method of harvesting energy from an expanding plasma, the method comprising: injecting a plasma into a container; sequentially applying a plurality of currents to a plurality of magnetic coils that are arranged to create a magnetic field within the container to sequentially change the magnetic field applied to the plasma, such that the plasma transitions to a stage where the plasma begins volumetrically expanding within the container and where the magnetic field resists radial expansion of the expanding plasma; and generating, based on the expanding plasma, harvestable current in at least one magnetic coil of the plurality of magnetic coils.

Some implementations relate to a method of harvesting energy from a plasma as it expands in a container, the method comprising: applying a plurality of currents to a plurality of magnetic coils that are arranged along a length of the container to create a magnetic field within the container, wherein the magnetic field maintains the plasma in a field-reversed configuration, resists radial expansion of the plasma, and allows axial expansion of the plasma along the length of the container; and receiving harvestable current from at least one magnetic coil of the plurality of magnetic coils during the axial expansion of the plasma, wherein the harvestable current is generated in the at least one magnetic coil by the plasma as it expands axially.

Some implementations relate to a method of confining a plasma and harvesting energy from the plasma as it expands, the method comprising: injecting the plasma into a container; applying a first plurality of currents to a plurality of magnetic coils that are arranged to create a magnetic field within the container, wherein the magnetic field prepares the plasma in a first state, wherein a radius of a separatrix of the plasma in the first state has a first radial value and a length of the separatrix has a first length value when the plasma is in the first state; applying a second plurality of currents to the plurality of magnetic coils that changes the magnetic field to transition the plasma from the first state to a second state, wherein the radius of the separatrix has a second radial value in the second state that is less than the first radial value and the separatrix has a second length value in the second state; applying a third plurality of currents to the plurality of magnetic coils that changes the magnetic field when the plasma transitions from the second state to a third state in which the plasma has more energy than in the second state and begins expanding beyond at least the second length, wherein the third plurality of currents are selected to create a magnetic field that resists expansion of the radius of the separatrix from the second radial value over at least a portion of the length of the separatrix while the length of the separatrix increases beyond the second length value; and receiving harvestable current from at least one magnetic coil of the plurality of magnetic coils while the length of the separatrix increases beyond the second length value, wherein the harvestable current is generated by the plasma as it expands beyond the second length.

Some implementations relate to a supply circuit for a magnetic field system, the supply circuit comprising: a first energy-storage component (C1); a first circuit branch coupled to a node of the first energy-storage component, the first circuit branch containing a first switch (SW2) arranged to conduct current between the first energy-storage component and at least one magnetic coil (130-1) of the magnetic field system when the first switch is in a conducting state; a second circuit branch coupled to the node of the first energy-storage component, the second circuit branch containing a second switch (SW4) arranged to conduct current between the first energy-storage component and an external load (210) when the second switch is in a conducting state and the first switch is in a non-conducting state; and a third circuit branch coupled to the node of the first energy-storage component, the third circuit branch containing a third switch (SW3) arranged to conduct current between the first energy-storage component and a second energy-storage component (L_{R}) to reverse a polarity of voltage across the first energy-storage component when the third switch is in a conducting state, the first switch is in a non-conducting state, and the second switch is in a non-conducting state.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1 depicts an example of a magnetic field system for producing intense magnetic fields.

FIG. 2 depicts an example of a supply circuit for delivering current to, recovering, and harvesting energy from at least one magnetic coil in the system of FIG. 1.

FIG. 3A depicts a magnetic field and plasma injection during an operational cycle of the system of FIG. 1.

FIG. 3B depicts a magnetic field and plasma configuration at a first time during an operational cycle of the system of FIG. 1.

FIG. 3C depicts a magnetic field and plasma configuration at a second time during an operational cycle of the system of FIG. 1.

FIG. 3D depicts a magnetic field and plasma configuration at a third time during an operational cycle of the system of FIG. 1.

FIG. 3E depicts a magnetic field and plasma configuration at a fourth time during an operational cycle of the system of FIG. 1.

FIG. 4A illustrates an example of the plasma's separatrix radius as a function of time during an operational cycle of the magnetic field system of FIG. 1.

FIG. 4B illustrates an example of the separatrix length as a function of time during an operational cycle of the magnetic field system of FIG. 1.

FIG. 4C plots an example of a current flow in the end coils 130-1 of the magnetic coil system of FIG. 1.

FIG. 4D plots an example of a current flow in the mid coils 130-2 of the magnetic coil system of FIG. 1.

FIG. 4E plots an example of a current flow in the central coil 130-3 of the magnetic coil system of FIG. 1.

FIG. 5 depicts further details of energy-harvesting circuitry for the magnetic field system of FIG. 1.

FIG. 6A depicts voltage waveforms associated with the energy-harvesting circuit of FIG. 5 and the supply circuit of FIG. 2.

FIG. 6B depicts a current waveform associated with the energy-harvesting circuit of FIG. 5 and the supply circuit of FIG. 2.

### DETAILED DESCRIPTION

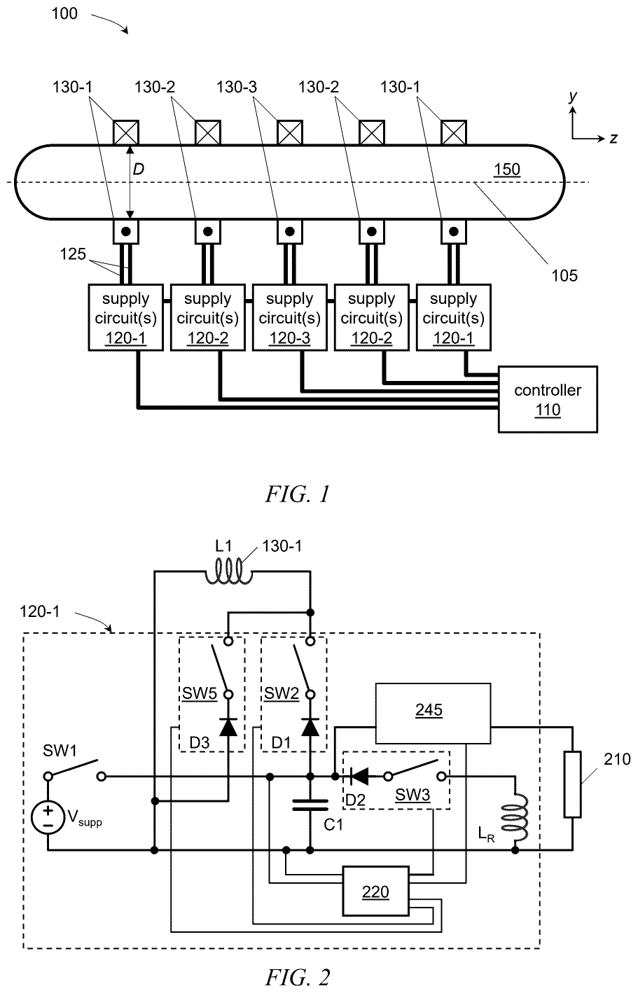

FIG. 1 depicts an example of a magnetic field system 100 that can be used to produce intense, dynamic magnetic fields (e.g., peak field values between 0.01 Tesla (T) and 50 T). The system 100 includes a plurality of magnetic coils 130-1, 130-2, 130-3 that are arranged to cooperatively produce a magnetic field within a container 150. To cooperatively produce a magnetic field, the magnetic coils 130 are spaced near enough to each other so that the magnetic field produced by any one coil adds to the magnetic field produced in the container 150 by at least one other coil in the system. For example, the space between adjacent coils 130-2, 130-3 can be equal to or less than the inner diameter D of the coil. The magnetic coils 130 can produce intense magnetic fields within the container 150 that is located adjacent to the magnetic coils 130. In the illustration, the container 150 and magnetic coils 130 are depicted in a cross-sectional view.

For some applications (particle or object acceleration), the container 150 may be a tube with at least one open end or can be formed in a loop. For other applications (plasma physics), the container 150 may be part of a larger a vacuum chamber with at least one entry port to introduce a plasma, for example. In such cases, the container may be made from a dielectric material such as quartz, and/or other related vacuum-compatible materials. In some cases, the container 150 can be a linear tube with entry ports at each end of the tube to inject plasmas from one or both ends. The relevant implementations of the plasmas include (i) coherent structures of plasmas and magnetic fields (plasmoids), and/or (ii) mirror-confined plasmas. In some implementations two plasmas are injected at each end of the container and are accelerated towards each other and collide at a center of the container. The collision can include a controlled merging of the injected plasmas, such that the resulting merged plasma maintains the same general structure of the injected plasmas. The collision can yield a fully merged plasma, partial merging of the plasmas, or no merging and the two plasmas maintain separate forms. In other implementations, a single plasma can already exist in the container or be injected from one side.

The magnetic coils may comprise multi-turn windings in some cases. In other cases, the magnetic coils may be formed as single-turn or multi-fed, fractional-turn magnetic coils. A single-turn or fractional-turn coil may comprise a solid, conductive, or superconducting core. An inner diameter of the coils (enclosing a space in which an intense magnetic field is produced) can be between 1 centimeter (cm) and 300 cm. Examples of such coils are described in International Patent Application PCT/US2022/033424 titled, “Inertially-Damped Segmented Coils for Generating High Magnetic Fields” filed Jun. 14, 2022, which application is incorporated herein by reference in its entirety.

Each of the magnetic coils 130 may be fed with electrical current from one or more supply circuits 120-1, 120-2, 120-3 (only one supply circuit is shown for each magnetic coil to simplify the illustration). The current may be provided over one or more supply lines 125 connected to each coil. The peak amount of current delivered to each coil can be, for example, between 100,000 amps (A) and 200,000,000 A.

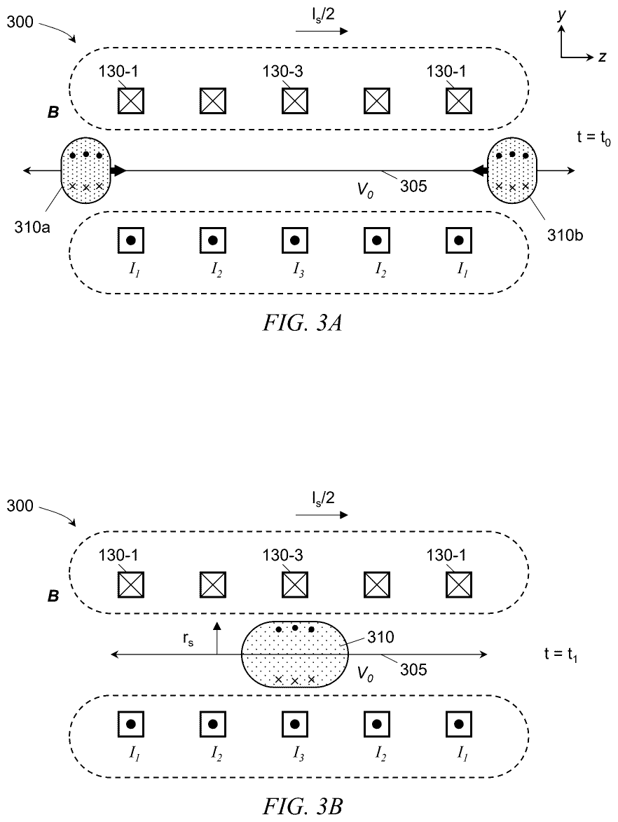

Each of the supply circuits 120 (explained in more detail with reference to FIG. 2 below) can include an electrical source (e.g., a voltage source), at least one energy-storage component (such as a battery, compulsator, flywheel, or capacitor; capacitors are especially useful in applications where fast energy discharge is desired), and at least one switch that gates the flow of current from the at least one energy-storage component to the associated magnetic coil. The switch(es) in each supply circuit 120 may be controlled independently of the switch(es) in other supply circuits 120 in the system (e.g., by a controller 110). As such, the current waveform and timing of the current waveform delivered to each of the magnetic coils 130 can be controlled independently, to a significant extent, of the current delivered to other magnetic coils 130 in the system 100. In some cases, structural limitations of the magnetic field system 100 may limit the amount of variation in amplitude, waveform, and/or timing between two or more of the magnetic coils 130.

A controller 110 can communicate with at least one of the supply circuits 120 to control at least the delivery of current from at least one supply circuit to one or more of the magnetic coils 130 (e.g., by activating the supply circuit's switch(es)). In some implementations, the controller 110 may additionally control an amount of current delivered by a supply circuit. In some cases, the controller 110 can further control a waveform of the current delivered (e.g., by selecting among discrete capacitive and/or resistive components and/or tuning tunable capacitive and/or resistive components in the supply circuits 120). The controller 110 may comprise a computer in some cases. In other cases, the controller may comprise a field-programmable gate array, a programmable logic circuit, an application-specific integrated circuit, a digital signal processor, or some combination thereof.

In some cases, the control of current delivery to the magnetic coils may be distributed among the supply circuits or among firing-control circuits coupled to the supply circuits. For example, the controller 110 may issue a command signal to deliver current to end coils 130-1. The command signal may be received by the end supply circuits 120-1, or the command signal may be received by a firing-control circuit coupled to the end supply circuits. Upon firing of the first coil 130-1, the end supply circuit 120-1 or firing-control circuit may issue a firing command signal to the mid supply circuit 120-2 or a firing-control circuit coupled to the mid supply circuit 120-2. In this manner, all magnetic coils can be fired, and the firing cycle can be repeated.

In some implementations, there can be one or more predetermined delays between the firing of the supply circuits 120 to energize their associated magnetic coils 130 in a successive firing order. For example, the magnetic coils 130-1 near the ends of the coil assembly may be energized first by their associated supply circuits 120-1 and then the firing of supply circuits progresses inward such that the central coil(s) 130-3 is (are) energized last in the succession. The delayed timing may be electronically programmable by the controller 110 or firing-control circuits in some cases. In some implementations, the delayed timing may be engineered with circuit delay elements connected to the supply circuits 120 that delay successive firing command signals after an initial firing command signal is provided to at least one of the supply circuits.

Regardless of how the timing of firing is determined, independent control (at least to some extent) of energizing each of the magnetic coils 130 is possible with the magnetic field system 100 of FIG. 1. With such independent control of the amplitude, waveform, and timing of current delivered to each of the magnetic coils 130, dynamic and pulsating, intense magnetic fields can be produced in the container 150. Firing command signals can be provided to the magnetic coils 130 in fast succession using fiberoptic cables and high-speed switches. In some cases, adjacent coils may fire within 10 nanoseconds of each other. Such rapid sequencing of firing command signals can allow careful control of the plasma through the magnetic coils to form, maintain, and transition the plasma between different states. Example circuits for controlling firing of supply circuits are described in International Patent Application PCT/US2022/033319, titled “High-Speed Switching Apparatus for Electromagnetic Coils,” filed Jun. 13, 2022, which application is incorporated herein by reference in its entirety.

FIG. 2 depicts one example of a supply circuit 120-1 that may be used to deliver current to, and receive current from, at least one magnetic coil 130-1 of the magnetic field system 100 of FIG. 1. The one or more magnetic coil(s) 130-1 connected to the supply circuit 120-1 can be modeled as an inductor L1. In operation, the supply circuit 120-1 can store and deliver energy to the magnetic coil(s) 130-1 to create a magnetic field that contains and controls a plasma within the container 150 (e.g., to compress the plasma in the radial and axial directions). The supply circuit 120-1 can include an energy-recovery circuit portion that recovers some of the energy delivered to the magnetic coil for storage and subsequent use in a next operational cycle, as described further below. The energy-recovery circuit portion includes, but is not limited to, inductor L_{R} and directional switch SW3. The supply-circuit can further include an energy-harvesting circuit 245 that can receive energy from the magnetic coil 130-1 to provide to an external load 210, as described further below. The energy-harvesting circuit 245 can include a switch that is activated to receive current from the energy-storage component C1, which can be implemented as one or more capacitors.

The supply circuit 120-1 includes the energy-storage component (modeled as a capacitor C1), a source (modeled as a voltage supply Vₛᵤₚₚ), switch SW1, and directional switches SW2, SW3, with diodes D1, D2. The directional switches may comprise silicon-controlled rectifiers (SCRs), for example, though other switches may be used. In operation, switch SW1 may be closed (with switches SW2, SW3, and SW5 open) to provide an initial charge to the energy-storage component C1. Switch SW1 may then open and switch SW2 close to deliver a pulse of current to the magnetic coil(s) 130-1. Unused energy from the pulse and/or electrical energy harvested from the magnetic coil(s) (which may in combination with the unused energy from the pulse exceed the amount of energy stored in capacitor C1 before the start of the pulse) 130-1 may pass through and accumulate charge in the capacitor C1. When a peak charge (of reverse polarity) has accumulated in the capacitor C1 which may be sensed by an optional sense and control circuit 220 in some implementations, switch SW2 may be opened and switch SW3 closed to invert the recovered energy in the energy-storage component C1 through a recovery circuit branch that includes another energy-storage component (inductor L_{R} in this example). The inversion can recharge the capacitor C1 to an initial polarity for a next cycle of operation.

The sense and control circuit 220, if used, can include a voltage sensor to detect a voltage on the charging node of the energy-storage component C1 and logic circuitry to output control signals to one or more of the switches SW2, SW3, SW5, and/or energy-harvesting circuit 245. If additional energy is harvested from the magnetic coil (which may be detected by the sense and control circuit 220 as a voltage exceeding a threshold voltage at the energy-storage component), the energy-harvesting circuit 245 can be activated to provide a portion of the harvested energy to an external load 210. The external load may or may not include a power conditioner to convert the output power into waveforms or DC voltage suitable for power applications (such as conventional two-phase or three-phase alternating current waveforms). In some implementations, the load 210 can comprise a power grid. Other supply circuits 120-1 that can recover unused energy that passes through the magnetic coil(s) 130-1 are also possible, and example supply circuits can be found in International Patent Application PCT/US2022/032277 titled, “Energy Recovery in Electrical Systems” filed Jun. 3, 2022, which application is incorporated by reference herein in its entirety and included in the Appendix attached to this application.

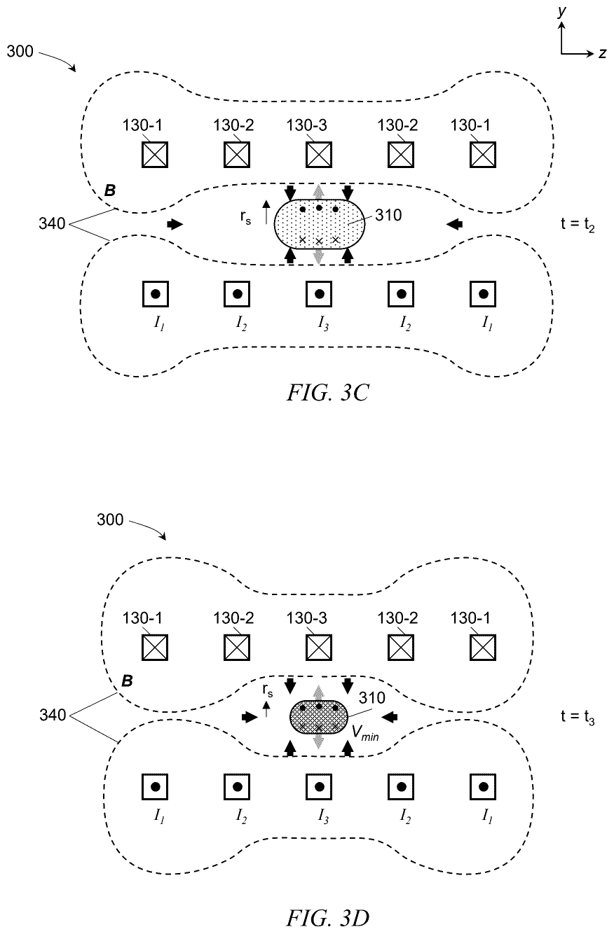

FIG. 3A, FIG. 3B, FIG. 3C, and FIG. 3D depict simplified time-sequenced images of example magnetic field lines B (dashed lines) and configurations of a contained plasma 310 for the magnetic field system 100 of FIG. 1.

The illustrations depict one example implementation in which a pulsating, intense magnetic field may be used to impart and extract energy directly and repeatedly from the plasma 310. In one embodiment, when the magnetic field system 100 collides two or more plasmas, as described above, in connection with FIG. 3A and FIG. 3B, there can be an increase in plasma energy and size as kinetic energy of the traveling plasmas is converted to plasma energy. In some cases, this increase in energy can also exert a back electromotive force (EMF) on the magnetic coil(s) of the system, producing additional current in the coils. The additional current can supplement current provided by the energy-storage component C1 and/or be recovered or harvested.

To simplify the drawings, the container 150, supply circuits 120, and controller 110 have been omitted and only the magnetic coil assembly 300 is shown along with the plasma. Magnetic field lines B are depicted rudimentarily with dashed lines and a spatial extent of the plasma 310 is depicted rudimentarily with a solid line (which may be the location of the separatrix for the plasma, for example). The separatrix is the location of the last closed magnetic field line within the plasma 310. Cross-sectional views are shown for the magnetic coil assembly 300 and plasma 310 though the magnetic coil assembly 300 and plasma 310 are three-dimensional. For example, the magnetic coils 130 and plasma 310 are symmetric with respect to a central axis 305 through the container. Although only five coils are shown in the illustrations, there can be 10 to 100 coils or more in a magnetic field system 100. Further, the illustrations may be for only a central portion of the magnetic field system. There can be additional coils at each end of the system to form and inject plasmas from each end toward the center of the magnetic field system where the plasmas merge.

To start an operational cycle for some implementations, two or more plasmoids 310a, 310b can be injected into the magnetic coil assembly 300, as depicted in FIG. 3A. As understood by those of ordinary skill in the art, a plasmoid is a coherent structure of plasma and magnetic fields. The plasmoids 310a, 310b can be formed in end regions of the magnetic coil assembly 300 and then accelerated toward each other using the magnetic coils 130. The plasmoids can merge within the magnetic coil assembly's container 150, forming a single plasma 310, rudimentarily depicted in FIG. 3B. The merging of plasmoids can add heat to the plasma 310. The plasma 310 may attain a first state in which the plasma is stable and has a separatrix radius rs and an axial length lₛ (in the +z directions). Note that in other configurations the plasmoids may partially merge or not merge but remain close together in a more confined space.

At a first time t=t₁, the magnetic field system 100 may be placed in an initial or first state for the operational cycle. Currents I₁, I₂, I₃ can be applied to the system's magnetic coils 130 to produce a magnetic field B that contains the plasma 310 to a first spatial extent. The plasma(s) may have a toroidal shape and be a field-reversed configuration (FRC) plasma. For example, the plasma can be mostly or fully ionized with fully magnetized electrons and likely further include magnetized ions. Further, the plasma can have significant diamagnetic currents and a plasma beta value β greater than or equal to 30%. The beta value is a ratio of pressure of the plasma, given by Eq. 2, to the magnetic pressure on the plasma, given by Eq. 1 below, averaged over the plasma's surface. The amounts of currents I₁, I₂, I₃ at time t₁ may be approximately equal for the initial state or increase slightly with distance from the center of the container to confine the plasma to the center of the container 150 and coil assembly 300. Because of the applied currents to the magnetic coils 130, an azimuthal current (indicated by the dots and crosses) that circulates around the plasma can be maintained in the container 150. In this initial state, the separatrix of the plasma may have an initial radius rs normal to the axis 305 and a half-length lₛ/2 in a direction along the axis 305. There can be an initial volume Vₒ of the plasma within the separatrix.

Subsequently, currents delivered to the magnetic coils 130 are increased to impart energy to the plasma 310 and transition the plasma from the initial state to a second state. At a second time t=t₂ at which the second state occurs, the volume of the plasma can be reduced compared to the volume of the plasma in the first state. FIG. 3C rudimentarily depicts the reduction of the plasma's volume. The increasing currents I₁, I₂, I₃ increase the strength of the magnetic field B which increases the magnetic pressure on the plasma 310 forcing the plasma radially inward and decreasing the volume of the plasma and increasing the plasma's internal temperature and pressure. The increased magnetic pressure is depicted as broad black arrows in the drawing pointing toward the top and bottom of the page. This increased pressure is exerted primarily radially around the circumference of the plasma. There can also be pressure exerted on the ends of the plasma reducing its length. The local magnetic pressure P_{B} acting on the plasma can be expressed as

$${P}_{B} = \frac{{B}^{2}}{2 {μ}_{0}} \qquad ( 1 )$$

where B is the local scalar magnitude of the magnetic field B and μₒ is the magnetic permeability of free space.

To further confine the plasma, the current applied to the magnetic coils 130 may be applied differently for each coil and in a time-sequenced manner. For example, the initial increase in the current I₃ applied to coils at the ends of the coil assembly (sometimes referred to as mirror coils) may be greater than the increase in current I₁ applied to coil(s) at the center of the coil assembly 300 initially to form magnetic field lobes 340 near the ends of the coil assembly, which are depicted in FIG. 3C. The dashed line roughly indicates a contour of equal magnetic field strength. The lobes 340 can exert magnetic pressure on the ends of the plasma to reduce its length.

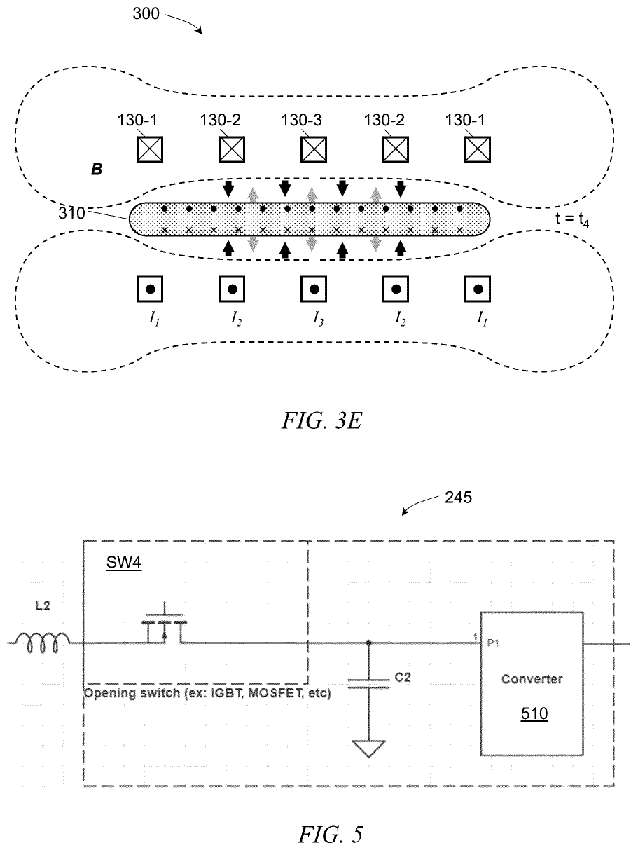

As depicted in FIG. 3D, these lobes 340 can be increased and/or propagated inward toward a center of the coil assembly 300 by sequencing a time-staggered increase in electrical currents applied to each adjacent coil in a direction moving toward a center of the coil assembly 300 (as described further in connection with FIG. 4C through FIG. 4E). For example, a peak increase in current I₃ can arrive at center magnetic coils 130-3 before a peak increase in current I₂ arrives at mid magnetic coils 130-2. This time-sequenced application of current can increase the magnetic pressure acting axially on the plasma, as indicated by the broad black arrows directed left and right on the page in FIG. 3C and FIG. 3D. In response to the magnetic pressure, the plasma 310 exerts pressure back on the magnetic field which is indicated by the broad gray arrows in the drawing. The counteracting pressure within the plasma can be expressed as

$$P = n {k}_{B} T \qquad ( 2 )$$

where n is a characteristic density value for the plasma (which may be one-half the peak density of the plasma), k_{B} is Boltzmann's constant, and T is a peak temperature of the plasma.

As depicted in FIG. 3D, when the plasma 310 reaches a minimum volume Vₘᵢₙ at a time t₃, such that the magnetic coils can compress it no further, the plasma's energy may increase or be increased. For example, an internal reaction (e.g., nuclear) may occur or energy from another source (such as a high-power laser, particle beam, or microwave heating) may be imparted to the plasma 310. The rapid increase in plasma energy or production of energy by the plasma can represent another state of the plasma. Example nuclear reactions include, but are not limited to, fusion (e.g., D-T fusion, D-D fusion and/or ³He-D fusion).

With the increased energy, the plasma 310 may begin expanding to an elongate shape as depicted in FIG. 3E as it transitions to yet another state. Energy may be liberated from the plasma and harvested by the magnetic coil assembly 300 during plasma expansion. The expanding plasma increases the magnetic field around the magnetic coils, producing an electromotive force via Lenz's law. The electromotive force (resonantly) drives current through the magnetic coils into the energy-storage element. This current recharges energy-storage components in at least some of the supply circuits 120. In some implementations, energy harvested from the expanding plasma along with energy recovered from the energy-recovery circuit together may exceed the energy delivered to the coil(s), with a portion of the excess energy realized by the system as useable energy through an energy-harvesting circuit that goes into another energy storage device or power an external load 210. Such a harvesting of energy represents a direct coupling of energy from the plasma.

In addition, regardless of the plasma expansion, energy can be drawn from the plasma in other ways. For example, a working gas could be passed over and around the plasma to liberate heat. In other implementations, charged particles or neutrons could eject from the plasma and transfer energy to a receiving material (such as a photovoltaic energy recovery system for charged particles, or molten blanket for neutrons). In some implementations, the heat generated by the plasma when producing energy may be captured and converted to electrical energy (e.g., by creating steam and driving a steam turbine). Such conversion processes represent an indirect coupling of energy from the plasma 310.

According to some implementations, the plasma 310 may be restricted in at least one dimension when it expands from a state at time t₃ to another state at a later time t₄, for which a configuration of the plasma is depicted rudimentarily in FIG. 3E. For example, the current applied to the interior magnetic coil(s) 130-2, 130-3 may be controlled (e.g., with a feedback loop or by applying predetermined waveforms to the coils) to locally resist expansion of the separatrix radius or maintain a constant separatrix radius rs while the plasma 310 expands, or to allow rs to expand in a controlled manner. To maintain the constant separatrix radius, an increased or restraining current may be applied to at least a portion of the magnetic coils 130 (e.g., interior coils 130-2).

In some cases, the current in one or more of the coils may be held using a circuit across the coil supply lines to resist plasma expansion. In some implementations, this is achieved by a crowbar circuit. The circuit may be within and activated by a supply circuit (e.g., closing switch SW5 by the sense and control circuit 220). In some implementations, the sense and control circuit 220 may control an amount of current in each coil by controlling the opening and closing of switches SW2, SW3, and SW5 and at least one switch in the energy-harvesting circuit 245. For example, the sense and control circuit 220 may crowbar one or more coils 130-3 (and possibly coils 130-2 too) near the center of the container 150 initially to resist radial plasma expansion at that location. As the plasma expands axially, expanding into coils that are not crowbarred (coils 130-1 and possibly coils 130-2), current can increase in those coils, generating and providing energy into their respective energy storage components C1 for energy harvesting. The coils into which the plasma expands can be the coils 130 that are used to otherwise guide the plasma. Additionally or alternatively, the coils into which the plasma expands can be additional auxiliary coils 135 (shown in FIG. 1) located between or outside the coils 130.

Crowbarring the central coil 130-3 prevents the plasma from expanding radially at the center of the container 150, causing (greater) axial expansion of the plasma instead. If desired, the current running through the central coil 130-3 can also be increased to radially over-compress the plasma at the center of the container 150, causing increased fusion energy generation and/or the plasma to lengthen (expand axially) by an even greater amount and/or at a faster rate, potentially generating more harvestable energy via axial expansion than otherwise possible.

In one implementation the circuit is timed such that majority component of the back EMF is created following achievement of peak current in the coils. As a result, the back EMF on net contributes to current flow in the direction of the overall circuit and towards recharging capacitor C1.

In a system with feedback control of the currents applied to the coils 130, voltage may be sensed on the magnetic coils to detect changes in the plasma's separatrix radius. (As understood by those of ordinary skill in the art, the separatrix radius can be determined from the voltage and the magnetic field.) Additionally or alternatively, diamagnetic probes and/or other magnetic sensors (such as sensing coil loops around the magnetic coils) may be located at one or more positions along the axis of the container 150 to detect rs at one or more positions along the axis of the container 150. There can be multiple sensors at each position along the axis of the container 150. The sensed voltages and/or magnetic fields can be processed in a feedback loop to determine an amount of current to apply to each magnetic coil to control the separatrix radius rs.

During an operational cycle between times t₁ and t₃, the increase in current values for at least one of the magnetic coils can be a factor having a value in a range from 1.5 to 10,000 (or any subrange within this range) from the initial current values at time t₁. The increase in magnitude of the magnetic field at a center of the container 150 may be by a factor having a value in a range from 1.5 to 10,000 (or any subrange within this range) and the reduction in plasma volume may be by a factor having a value in a range from 2 to 1,000 (or any subrange within this range) during the time interval from t₁ to t₃. The radius of the plasma's separatrix may decrease by a factor having a value in a range from 1.5 to 20 (or any subrange within this range, e.g., from 1.5 to 5) compared to an initial value rₛᵢ before the currents were increased. An initial value of rₛᵢ may be between 1 cm and 100 cm. The length of the separatrix may decrease by a factor having a value in a range from 1.5 to 50 (or any subrange within this range) compared to an initial value of the length before the currents were increased to compress the plasma 310. An initial length of the separatrix may be between 5 cm and 5 m. The time interval from t₁ from t₃ can be a duration of time having a value in a range from 1 nanosecond to 100 milliseconds (or any subrange within this range).

By maintaining a constant separatrix radius (or allowing rs to expand controllably), the plasma 310 continues to be well coupled to the coil assembly 300. The plasma and its azimuthal current wall can then be allowed to expand primarily axially along the coil assembly 300 achieving a longest length at time t₄, as depicted in FIG. 3E. As the plasma expands axially, the currents in the magnetic coils 130 may be controlled in sequence to maintain a fixed and approximately equivalent separatrix radius rs along at least a central portion of the coil assembly 300. In some cases, the radius rs may be allowed to expand in a controllable manner. The axial flux of plasma current and associated magnetic field can generate current(s) in one or more magnetic coils of the coil assembly 300 or in one or more auxiliary magnetic coils distributed along the container 150. The generated current(s) can be harvested as usable energy. Such a method of harvesting energy represents a direct coupling of energy from the plasma. In some cases, the same coils that are used to control expansion of the plasma (e.g., maintaining an approximately constant separatrix radius while the plasma expands axially) are used to harvest energy from the expanding plasma.

After time t₄, the plasma 310 may have imparted an amount of energy to the coil assembly and cooled to the extent that it can no longer provide harvestable energy and/or maintain its expanded volume. In some cases, the plasma 310 may then start contracting back to the initial state depicted in FIG. 3B. The currents to the magnetic coils may be adjusted such that the plasma returns to the initial state for the next operational cycle.

During this process, portions of the plasma 310 can leak out of the ends of the container 150. The magnetic field accelerates the leaking portions of plasma, producing jets of high-velocity particles that move away from the center of the container 150 along the container's longitudinal axis. Particles may leak out of the container 150 continuously throughout the process illustrated in FIGS. 3A-3E. In some cases, the plasma 310 may decay into an open field line plasma after the time t₄.

New plasma may be injected with each cycle (e.g., after time to) to replenish the supply of components that can react when the plasma is compressed on the next cycle. Removal and injection of plasma can be controlled by one or more magnetic coils located at the ends of the magnetic field assembly 100. The steps of plasma injection, compression, constrained expansion, harvesting energy, and removal of products may then be repeated cyclically during operation of the magnetic field system 100.

Plasma configurations in addition to or other than the states described above may be attained in some implementations of the system. For example, in the third state the axial expansion of the plasma may be asymmetric, and the plasma could even be ejected in one direction (for example, to create a propulsive effect). In some cases, the plasma may oscillate between different states one or more times during an operational cycle (e.g., oscillate between the plasma state at time t₂ depicted in FIG. 3C and the plasma state at time t₃ depicted in FIG. 3D one or more times).

In some implementations, the supply circuits 120 may be used to utilize electrical energy harvested from the magnetic coils 130 during plasma expansion. For example, a portion of the harvested electrical energy (which may in combination with energy recovered from the energy recovery circuit exceed the energy supplied to the magnetic coils) may be stored in the energy-storage component(s) of the power supply circuits and or additional energy-storage components that can be switched into connection with the magnetic coils. Another portion of the harvested energy can be provided to a load 210 as described in connection with FIG. 2 and described further below. A load 210 can be any device that consumes or stores electrical energy, including a power grid. At least some of the stored energy may be dumped to an external load during one or more intervals of the operational cycle (e.g., when the plasma contracts from a fully expanded volume to an initial-state volume Vₒ). Some of the stored energy may be retained for a next operational cycle of the magnetic field system.

FIG. 4A through FIG. 4E plot example dynamics of plasma and current characteristics for an operational cycle of the magnetic field system of FIG. 1, according to some implementations. For this example, the separatrix radius rs of the plasma may evolve in time, for at least a portion of a compression/expansion cycle, as depicted in FIG. 4A. The separatrix radius rs may start the operational cycle at time t₀ with an initial radius rₛᵢ and be reduced by the increasingly intense magnetic fields to a minimum radius rₘᵢₙ at time t₃. Then for some cases, the separatrix radius may be held approximately constant (e.g., to within 10% or to within 20% of rₘᵢₙ) between the times t₃ and t₄ as the length of the separatrix lₛ is allowed to expand within the magnetic field system 100, as illustrated further with FIG. 4B. To maintain an approximately constant radius rs, the local magnetic pressure P_{B} acting radially on sidewalls of the plasma approximately equals the local plasma pressure P acting radially outward. Alternatively, holding rs approximately constant can be expressed as maintaining a beta β for the plasma's sidewalls to be approximately equal to 1, where β=P/P_{B}. In some cases, the separatrix radius may be controlled in a manner to allow some expansion of the separatrix radius (e.g., by as much as 50% during the time interval from t₃ to t₄). Such control of rs (whether restrained to be approximately constant or allowed to expand controllably) may be achieved by controlling the current waveforms applied to the magnetic coils 130 of the magnetic field system 100. At later stages of the operational cycle (after t₄), the separatrix's radius and length may return to an initial state as the current pulses applied to at least a portion of the magnetic coils 130 fall and return to initial values for the start of a next operational cycle.

The duration of an operational cycle, as depicted in FIG. 4A through FIG. 4E, may be from approximately or exactly 1 microsecond to approximately or exactly 1,000 milliseconds (or any subrange within this range). However, shorter or longer durations may be possible in some implementations. In some cases, each operational cycle may further include a recovery interval (e.g., between time t₄ and the application of current pulses to the magnetic coils for the next operational cycle). The recovery interval may allow time for heat dissipation and/or reinitialization of system components (e.g., heat dissipation in the container 150, heat dissipation in and resetting of switches of supply circuits 120, recharging of energy-storage components in the supply circuits 120, removal of spent plasma, injection of new plasma, etc.).

FIG. 4C through FIG. 4E depict examples of current waveforms that may be applied to some magnetic coils 130 of the system of FIG. 1 to produce the dynamic behavior of rs and Is that is depicted in FIG. 4A and FIG. 4B, respectively. The shapes of the waveforms can determine the dynamic behavior of rs and lₛ. The example waveforms indicate that during the time interval t₀ to t₂ a higher current arrives first at the end coils 130-1, then at the mid coils 130-2, and last at the central coil(s) 130-3. The waveforms during the time interval from t₃ to t₄ may be controlled in a way to restrain the separatrix radius rs to approximately its minimum value rₘᵢₙ as described above, or to expand in a controlled manner as indicated in FIG. 4A. In some cases, controlled expansion of the separatrix radius rs may improve particle confinement time and stability of the plasma 310.

FIG. 4D depicts an example of the current waveforms applied to the mid coils 130-2. The current waveforms applied to the mid coils may be similar to the current waveform applied to the central coil(s) 130-1 during the time interval from t₃ to t₄, since the separatrix radius may also be restrained by the mid coils to an approximately constant value or allowed to expand controllably.

FIG. 4E depicts an example of the current waveforms applied to the central coil 130-3. The current waveforms applied to the central coil may fall more quickly than the current waveforms applied to the mid coils and end coils during the time interval from t₃ to t₄ to allow expansion of the plasma 310 in length and radius at the ends of the plasma 310. This faster reduction in current for the central coil may be beneficial to allow the expanding plasma 310 to drive more magnetic flux through the end coils of the magnetic field system 100 and generate more harvestable current.

The depictions of plasma configurations in FIG. 3A through FIG. 3E are rudimentary illustrations of plasma configurations at snapshots in time and that the plasma may pass through these configurations quickly during an operational cycle of the system. Similarly, the waveforms of FIG. 4A through FIG. 4E rudimentarily indicate evolution of currents applied to magnetic coils 130 of the magnetic field system 100. As well, in certain configurations, such as the crowbar circuit configuration in which the center coil(s) maintains or over-compresses the center of the plasmoid, then the figures could look further different (e.g., longer or faster axial expansion, peak currents maintained on the center coil for longer). At any snapshot in time, the plasma 310 can be said to be in a particular state having a certain size, configuration, and energy. Accordingly, the plasma 310 can pass quickly through many states during an operational cycle of the system 100.

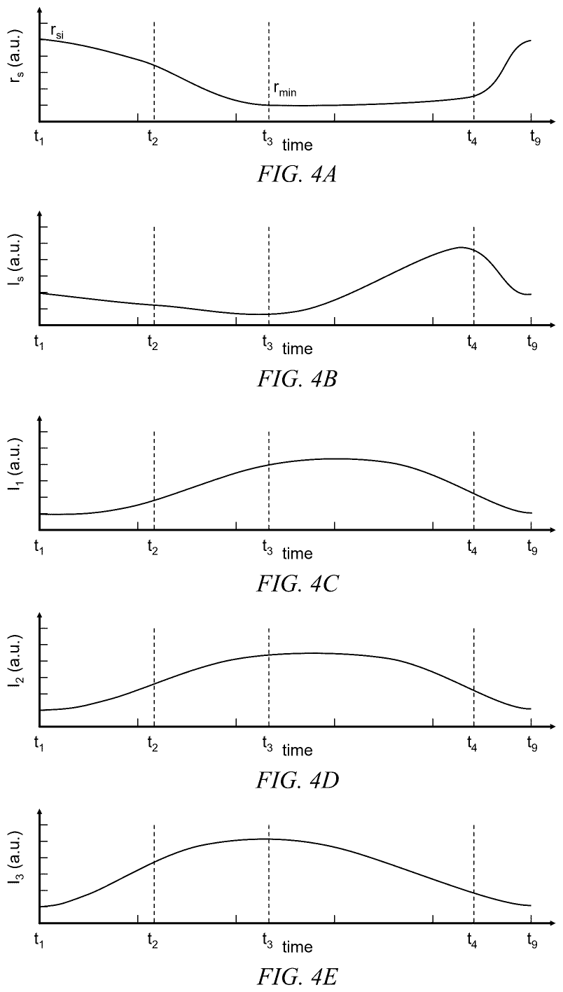

FIG. 5 depicts an example energy-harvesting circuit 245 that can be used with the magnetic field system of FIG. 1 and FIG. 2. In FIG. 5, the circuit 245 includes an opening switch SW4 (implemented as a MOSFET), a capacitor C2, and a power converter 510 (e.g., DC-to-AC converter). Other types of power converters can be used in other implementations (e.g., DC-to-DC converter). Power from the power converter 510 can be provided to any suitable load, including a commercial AC power grid. The energy-harvesting circuit 245 can further include an inductor L2 (operating at least in part as a choke, for example) at its input that couples to the energy-storage component C1 of the supply circuit 120-1, as depicted in FIG. 2. The energy-storage component C1 is the same component to which energy is recovered via the energy-recovery circuit described above and in International Patent Application PCT/US2022/032277 titled, “Energy Recovery in Electrical Systems,” referred to above. Accordingly, the energy-harvesting circuit 245 can work in combination with these energy-recovery circuits in the magnetic field system 100. For high-power applications, the components of the energy-harvesting circuit 245 should be able to handle high voltages and large amounts of currents (e.g., at least 103 volts and at least 103 amps).

The opening switch SW4 is a switch that can open when current is flowing through the switch. Examples of such a switch include a silicon-controlled rectifier or an insulated-gate bipolar transistor (IGBT). Another example of such a switch is a power metal-oxide-semiconductor field-effect transistor (power MOSFET). Other types of opening switches can be used for the energy-harvesting circuit 245.

The capacitor C2 can be used to temporarily store energy received from the magnetic coil(s) 130-1 for power conversion by the power converter 510. In some implementations, the capacitor C2 may not be included, and instead the energy-storage component C1 of the supply circuit 120-1 is used to store a portion of harvested energy prior to power conversion by the power converter 510 and delivery to the external load 210. In such implementations, the inductor and/or switch SW4 can couple directly to the energy-storage component C1.

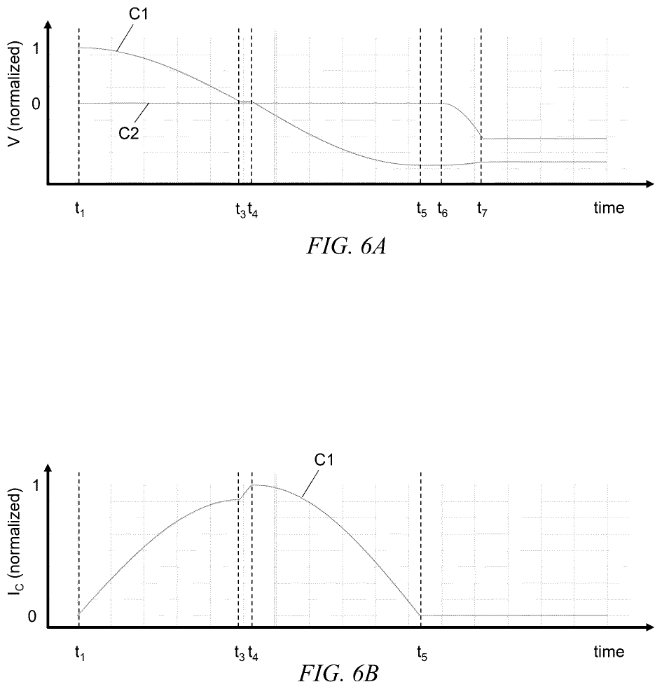

FIGS. 6A and 6B depict voltage waveforms and a current waveform, respectively, associated with the energy-harvesting circuit 245 of FIG. 5 and supply circuit 120-1 of FIG. 2. These waveforms can occur during each operational cycle of the magnetic field system 100, and the operational cycles can be repeated regularly (e.g., once per 10 seconds, once per second, or more than once per second). The traces in FIG. 6A show voltages across capacitor C1 and across capacitor C2. FIG. 6B plots current flow in capacitor C1.

To start an operational cycle at a time t₁, the voltage on energy-storage component C1 is charged to an initial value by the supply circuit 120-1. The initial value in FIG. 6A is normalized to 1 but could be any value from 100 volts to 100 kV. While C1 is being charged, switch SW1 (FIG. 2) is closed to deliver energy to the energy-storage component C1 and switches SW2, SW3, and SW4 are open to prevent current flow in their respective circuit branches.

At time t₁, SW1 opens (transitions to a non-conducting state) and SW2 closes (transitions to a conducting state) to provide current to the magnetic coil(s) 130-1, creating a magnetic field that helps compress the plasma in the container 150. Similar action occurs in other supply circuits 120 in the system as described above in connection with FIG. 3A through FIG. 3D and FIG. 4C through FIG. 4E. As current flows out of the energy-storage component C1 (indicated in FIG. 6B), the voltage across the capacitor drops (indicated in FIG. 6A) while the plasma compresses to a minimum size at time t₃ as illustrated in FIG. 3D.

In some implementations, switch SW2 closes in response to a control signal from sense and control circuit 220. For example, sense and control circuit 220 detects a voltage level exceeding a preset threshold voltage and issues a control signal to close switch SW2. In other implementations, switch SW2 closes automatically. For example, switch SW2 is implemented as an SCR that closes automatically when a voltage across the switch exceeds a threshold value (e.g., exceeds the switch's breakover voltage).

At time t₃, a reaction in the plasma may initiate expansion of the plasma's length (axially along the container 150 as indicated by the interval from t₃ to t₄ in FIGS. 3E and 4B and described above). This expansion can create a back electromotive force in the magnetic coil(s) 130 that imparts additional energy and current flow in the coil(s) (as described above). This additional energy causes an increase in current flow, depicted over the interval from t₃ to t₄ in FIG. 6B. This increased current flow can contribute to recharging the energy-storage component C1.

The increased current flow in the magnetic coils over the interval from t₃ to t₄ can contribute to constraining the radius of the separatrix rs as the plasma expands axially. For example, the current flow is in a direction that increases the magnetic field produced by the coil(s) and acts to compress the plasma.

At time t₅, the energy-storage component C1 has received enough charge to initiate a next stage of operation. When C1 has been sufficiently recharged or charged beyond a certain value, switch SW2 opens to prevent further charging of the energy-storage component C1. In some cases, switch SW2 may be opened in response to detecting a voltage across C1 that exceeds a threshold level. For example, sense and control circuit 220 may detect a voltage across C1 and issue a control signal to open switch SW2. In other implementation, switch SW2 can open automatically. For example, the switch can be implemented as an SCR that opens automatically when the current through the switch drops below a threshold value (such as the latching current).

When SW2 opens, or shortly thereafter at time to, the energy-harvesting circuit 245 is activated. The activation can comprise closing of a switch SW4 to allow current from the magnetic coil(s) 130-1 to flow through the inductor L2 and to the capacitor C2 (if present) and/or the power converter 510. FIG. 6A shows the charging of capacitor C2 until time t₇ when switch SW4 opens. The closing and opening of switch SW4 can be in response to control signals from the sense and control circuit 220. In this manner, energy can be harvested from the magnetic field system 100. The time span from t₁ to t₇ can be from 1 microseconds to 100 milliseconds (e.g., 10 microseconds, 100 microseconds, 1 millisecond, 10 milliseconds, or any other value between 1 microsecond and 100 milliseconds) for some magnetic field systems, though shorter or longer time spans may be possible.

In some implementations, the charge on the energy-storage component C1 can be reversed with the energy-recovery circuit branch that includes switch SW3 and inductor L_{R}. For example, after time t₇ switch SW3 is closed to reverse the polarity of voltage across C1 and then opened. In other cases, the charge on the energy-storage component C1 can be reversed prior to energy harvesting with the energy-harvesting circuit 245. For example, switch SW3 can be closed to reverse the polarity of voltage across C1 and then opened before switch SW4 is closed. Operating the system this way would reverse the polarity of voltage accumulated on capacitor C2, but still functionally charge the capacitor for use in future cycles.

For some implementations of the magnetic field system 100, the energy harvested from the expanding plasma by the energy-harvesting circuit 245 is the majority of, or only, energy obtained from the magnetic field system 100. This energy can be retained for future device operation and/or provided to an external load. Although in some cases this energy may be a small percentage of total energy produced by the plasma after a reaction occurs (or the energy produced by the plasma may itself be small), it can be surplus energy from the system when the system uses an energy-recovery circuit to recharge the energy-storage component C1 as described above. The energy-recovery circuit can provide enough system efficiency such that energy harvested by the expanding plasma becomes surplus energy for other applications.

Although the discussion of energy harvesting above is for a plasma that expands primarily axially along the container 150, radial expansion of the plasma along the center coils 130-1 can also contribute to the back EMF in the coil(s) 130 and production of harvestable energy from the system. That is, in some systems, axial and radial expansion of the plasma can occur during the time interval from t₃ to t₄.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A method of harvesting energy from a plasma, the method comprising:
adiabatically compressing the plasma with a magnetic field with magnetic coils so as to cause the plasma to undergo compression, heating, and fusion, the compression, heating, and fusion causing the plasma to undergo axial expansion, the axial expansion of the plasma transferring energy to the magnetic coils; and
directing the energy from the magnetic coils to an energy-storage component.

2. The method of claim 1, wherein the plasma is a field-reversed configuration (FRC) plasma.

3. The method of claim 1, wherein adiabatically compressing the plasma comprises:
increasing current running through the magnetic coils so as to increase an amplitude of the magnetic field.

4. The method of claim 1, wherein directing the energy from the magnetic coils to an energy-storage component comprises resonantly transferring the energy from the magnetic coils to the energy-storage component.

5. The method of claim 1, further comprising, while the plasma undergoes the compression, heating, and fusion:
crowbarring current in at least one of the magnetic coils to further resist radial expansion of the plasma and promote the axial expansion of the plasma.

6. The method of claim 1, further comprising, while the plasma undergoes the compression, heating, and fusion:
radially over-compressing the plasma to promote the axial expansion of the plasma.

7. The method of claim 1, wherein the compression, heating, and fusion causes radial expansion of the plasma, the radial expansion of the plasma generating additional current in the magnetic coils, and further comprising:
storing the additional current as additional energy in the energy-storage component.

8. The method of claim 1, further comprising:
converting energy from the energy-storage component into an electrical current.

9. The method of claim 8, wherein the energy-storage component comprises at least one capacitor and the electrical current is direct current.

10. The method of claim 8, wherein the energy-storage component comprises at least one capacitor and the electrical current is alternating current.

11. A system for harvesting energy from a plasma, the system comprising:
magnetic coils configured to adiabatically compress the plasma with a magnetic field so as to cause the plasma to undergo compression, heating, and fusion, the compression, heating, and fusion causing the plasma to undergo axial expansion, the axial expansion of the plasma transferring energy to the magnetic coils; and
an energy-storage component, operably coupled to the magnetic coils, to receive the energy from the magnetic coils.

12. The system of claim 11, wherein the plasma is a field-reversed configuration (FRC) plasma.

13. The system of claim 11, wherein the magnetic coils are configured to resonantly transfer the energy to the energy-storage component.

14. The system of claim 11, wherein the magnetic coils are configured to radially over-compress the plasma to promote the axial expansion of the plasma.

15. The system of claim 11, wherein the compression, heating, and fusion causes radial expansion of the plasma, the radial expansion of the plasma generating additional current in the magnetic coils, and wherein the energy-storage component is configured to receive the additional current from the magnetic coils.

16. The system of claim 11, further comprising:
at least one supply circuit, operably coupled to the magnetic coils, to supply current to the magnetic coils so as to produce the magnetic field.

17. The system of claim 16, wherein the at least one supply circuit is configured to crowbar current in at least one of the magnetic coils to further resist radial expansion of the plasma and promote the axial expansion of the plasma while the plasma undergoes the compression, heating, and fusion.

18. A method of harvesting energy from a plasma as it expands in a container, the method comprising:
applying currents to magnetic coils arranged along a length of the container to create a magnetic field within the container, wherein the magnetic field maintains the plasma in a field-reversed configuration, resists radial expansion of the plasma, and allows axial expansion of the plasma along the length of the container; and
receiving harvested current in an energy-storage component from at least one of the magnetic coils during the axial expansion of the plasma, wherein the harvested current was generated by the at least one of the magnetic coils by the axial expansion of the plasma.

19. The method of claim 18, wherein the energy-storage component comprises at least one capacitor.

20. The method of claim 19, further comprising:
converting energy from the energy-storage component into an electrical current.
